(19) United States
(12) Patent Application Publication
(10) Pub. No.: US 2003/0081807 A1
(43) Pub. Date: May 1, 2003

(54) Speaker and method for manufacturing the speaker

(75) Inventor: Masahito Furuya, Yamanashi-ken (JP)

Correspondence Address: Ira J. Schultz, DENNISON, SCHULTZ & DOUGHERTY, 1745 Jefferson Davis Highway, Suite 612, Arlington, VA, 22202, US

(73) Assignee: CITIZEN ELECTRONICS, CO., LTD.

(21) Appl. No.: 10/269,889

(22) Filed: Oct. 15, 2002

(30) Foreign Application Priority Data
Oct. 30, 2001 (JP) 2001-333562

(51) Int. Cl. H04R 1/02; H04R 1/00; H04R 9/06; H04R 11/02

(52) U.S. Cl. 381/396; 381/395

(57) ABSTRACT

A speaker has a case having a peripheral projection, a magnetic device having a yoke, and a permanent magnet and secured to the case. A diaphragm is secured to the case at the peripheral projection. A protector has an upper plate and a cylindrical holding portion at the periphery of the upper plate. The protector is secured to the case at the cylindrical holding portion.

### BACKGROUND OF THE INVENTION

The present invention relates to a speaker used in a portable communication equipment such as a portable telephone and other equipments.

Referring to FIG. 6 showing a conventional speaker, a yoke 2 made of magnetic material is embedded in a case 1 made of plastic by insert molding. A permanent magnet 3 is secured to the yoke 2, and a top plate 4 made of magnetic material is adhered to the magnet 3 to form a magnetic circuit and to form a magnetic gap between the top plate 4 and the yoke 2.

A diaphragm 6 is secured to the case 1 at a shoulder 1b of the periphery thereof. A voice coil 5 secured to the underside of the diaphragm 6 is inserted in the magnetic gap. A protector 7made of metal is secured to the case 1, interposing the diaphragm 6. A plurality of sound discharge holes 7a are formed in the protector 7. The diaphragm 6 and the protector 7 are positioned by a cylindrical peripheral projection 1a.

A pair of ends 9 of the voice coil 5 are outwardly extended from the case 1 passing through a groove 1c formed in a peripheral wall of the case. On the underside of the case 1, a substrate 8 made of plastic is adhered, and a pair of terminal plates 10 are secured to the substrate 8. Each of ends 9 is connected to one of the terminal plate 10 by solder 11. The terminal plate 10 is connected to a circuit of the equipment to be mounted therein.

Thus, when a signal current is applied to the voice coil 5 through the terminal plates 10, the diaphragm 6 vibrates to produce sounds.

In the above described conventional speaker, the diaphragm 6 is positioned by the peripheral projection la and secured to the shoulder 1b. Therefore, the effective diameter dφ of the diaphragm 6 is reduced by double of width of the peripheral projection 1a. The reduction of the diameter of the diaphragm causes the quality of the produced sound to deteriorate.

On the other hand, there are problems in manufacturing of the speaker. In the manufacturing, after the diaphragm 6 and the protector 7 are secured to the shoulder 1b the case 1 is inverted in order to solder the ends 9 to terminal plates 10. However, the inverting operation of the case causes the manufacturing operation of the speaker to complicate.

### SUMMARY OF THE INVENTION

An object of the present invention is to provide a speaker which may obviate the above described troubles.

According to the present invention is to provide a speaker comprising a case having a peripheral projection, a magnetic device having a yoke, and a permanent magnet and secured to the case, a diaphragm secured to the case at the peripheral projection, a voice coil secured to an underside of the diaphragm, and a protector having an upper plate and a cylindrical holding portion at a periphery of the upper plate and secured to the case at the cylindrical holding portion.

The speaker according to claim 1 wherein the cylindrical holding portion of the protector has an axial length so as to overlap with the peripheral projection of the case in order to secure the protector to the case.

The speaker according to claim 1 further comprising a hold ring provided in the protector for securing the diaphragm to the case.

The speaker according to claim 1 wherein the protector has a stepped hold portion between the upper plate and the cylindrical holding portion, and the diaphragm is secured to the case by the stepped hold portion.

A method for manufacturing a speaker comprising steps of providing an assembly of a case having a peripheral projection and terminals on an underside, thereof and a magnetic device having a yoke, and a permanent magnet, providing a diaphragm having a voice coil secured to an underside of the diaphragm, providing a protector having an upper plate and a cylindrical holding portion at a periphery of the upper plate, mounting the protector on a base in an inverted position, inserting the voice coil in the protector in an inverted position, pulling out a pair of ends of the voice coil, inserting the assembly in the protector in an inverted position, securing the cylindrical holding portion of the protector to the peripheral projection of the case, and connecting the ends of the voice coil to the terminals on the case.

These and other objects and features of the present invention will become more apparent from the following detailed description with reference to the accompanying drawings.

### BRIEF DESCRIPTION OF DRAWINGS

FIG. 1 is a sectional view showing a speaker according to a first embodiment of the present invention;

FIG. 2 is a plan view showing the underside of the speaker;

FIG. 3 is a plan view showing the underside of a protector;

FIG. 4 is an exploded sectional view for explaining manufacturing process of the speaker;

FIG. 5 is a sectional view showing a protector according to a second embodiment of the present invention; and

FIG. 6 is a sectional view of a conventional speaker.

### DETAILED DESCRIPTION OF THE PREFERRED EMBODIMENT

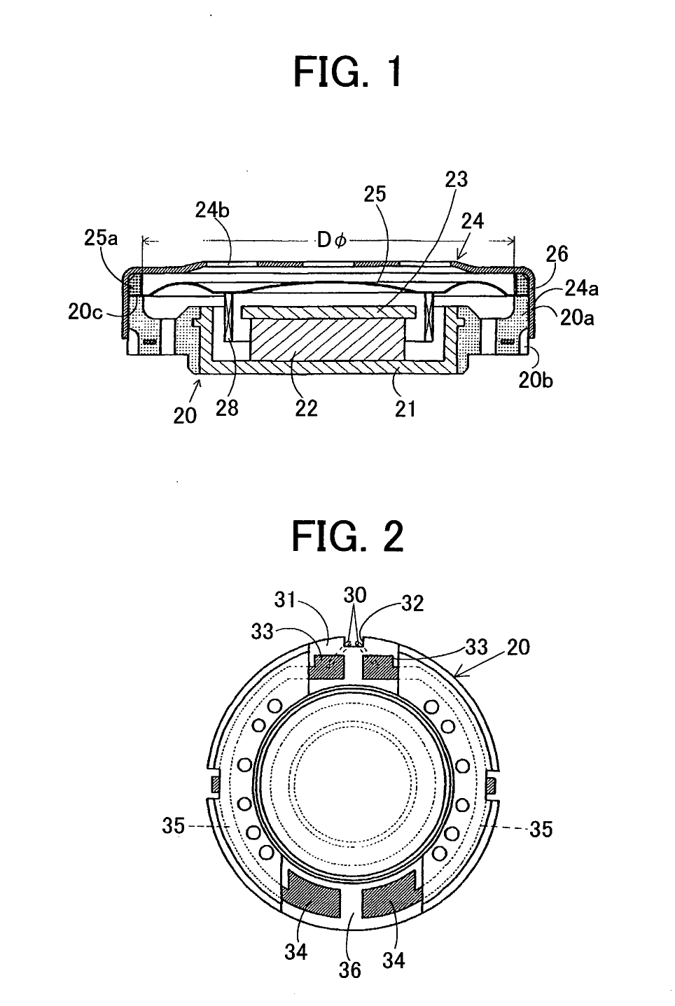

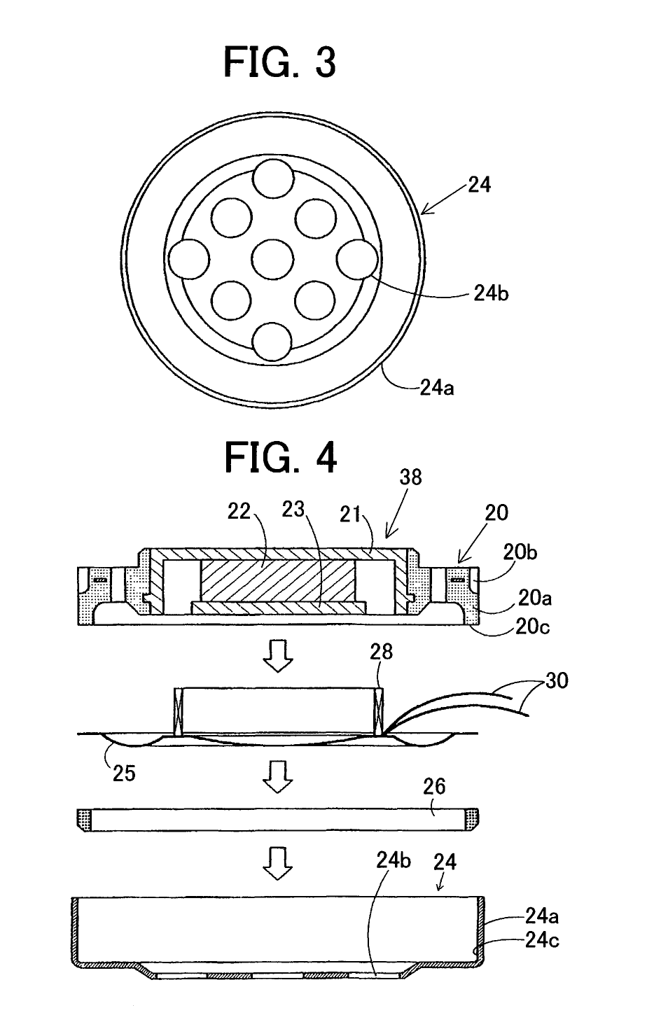

Referring to FIG. 1, a case 20 made of plastic has a peripheral cylindrical projection 20a having a flat top surface. The speaker comprises a yoke 21 made of magnetic material and embedded in the case 20 by insert molding, a permanent magnet 22 secured to the yoke 21, and a top plate 23 adhered to the magnet 22.

A protector 24 comprises an upper plate 24c and a cylindrical holding portion 24a downwardly extending from the periphery of the upper plate 24c. A diaphragm 25 is held between a hold ring 26 provided in the protector 24 and the peripheral projection 20a of the case 20 at a peripheral portion 25a. The holding portion 24a of protector 24 has a length overlapping with the projection 20a of the case 20 and is secured to the case 20 by an adhesive set in an annular groove 20b formed in the peripheral wall of the case. A voice coil 38 secured to the underside of the diaphragm 25 is inserted in the magnetic gap between the top plate 23 and the yoke 21. A plurality of sound discharge holes 24b are formed in the protector 24. A pair of ends 30(FIG. 4) of the voice coil 28 are adhered to the underside of the diaphragm 25.

Referring to FIG. 2, the ends 30 are introduced in a recess 31 formed in the underside of the case 20, passing through a guide groove 32 of the peripheral wall of the case. Each end 30 is connected to an end plate 33 adhered on the underside of the case. The end plate 33 is connected to a terminal plate 34 in a recess 36 at the opposite side by a lead 35 embedded in the case. The terminal plate 34 is contacted with a terminal of an equipment in which the speaker is mounted.

The diaphragm 25 is accurately centered by the engagement of the periphery thereof with the inside wall of the protector 24. Since the top 20c of the peripheral projection 20a of the case 20 is flat without shoulder, the width of the top surface can be largely reduced, and the effective diameter Dφ of the diaphragm 25 can be increased compared with the width of the conventional peripheral projection. Thus, it is possible to provide a speaker producing a high-quality sound.

The method for manufacturing the speaker of the first embodiment of the present invention is described hereinafter with reference to FIG. 4.

The protector 24 is mounted on a base (not shown) in an inverted position, and the hold ring 26 is inserted in protector 24 and disposed on the bottom corner 24c. Then, the diaphragm 25 having the voice coil 28 is inserted in the protector, and a preliminarily assembled magnetic device and case assembly 38 is inserted in the protector 24 in the inverted position by the guiding of the cylindrical periphery 24a of the protector 24. Thereafter, an adhesive is poured in the annular groove 20b of the case, under the condition that the magnetic device and case assembly 38 are pressed against the hold ring 26. The ends 30 of the voice coil 28 are connected to the end plates 33 (FIG. 2). Thus, the speaker is completed without inverting the parts during the manufacturing process.

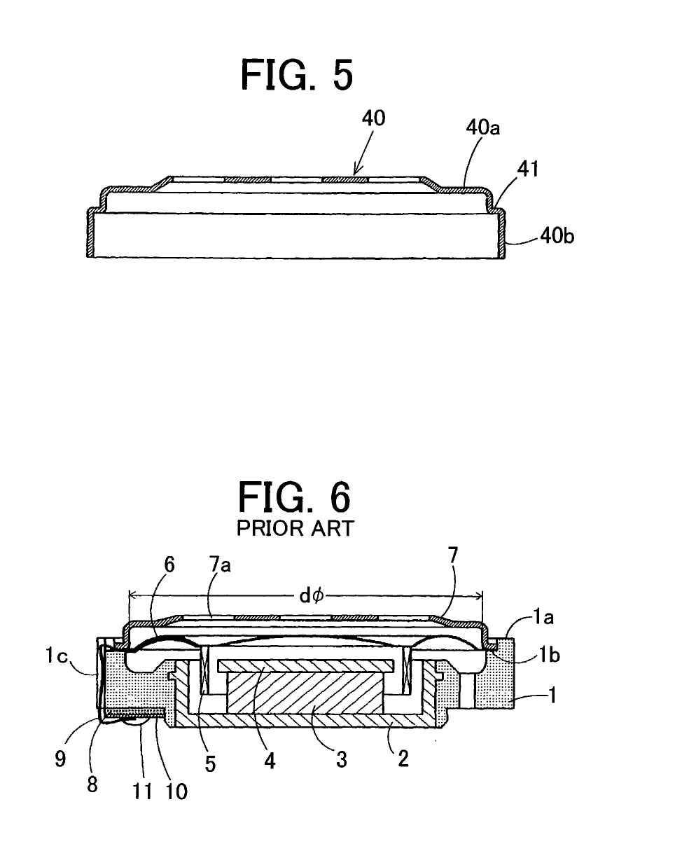

Referring to FIG. 5 showing a protector in the second embodiment, the protector 40 has a stepped hold portion 41 between a top plate 40a and a cylindrical holding portion 40b. The peripheral portion of the diaphragm 25 is caught by the stepped hold portion 41 and the projection 20a of the case 20. Thus, the hold ring 26 in the first embodiment is omitted, thereby reducing the number of parts of the speaker.

In accordance with the present invention, the effective area of the diaphragm can be increased compared with the conventional speaker. Furthermore, the speaker can be manufactured in simple steps.

While the invention has been described in conjunction with preferred specific embodiment thereof, it will be understood that this description is intended to illustrate and not limit the scope of the invention, which is defined by the following claims.

What is claimed is:

1. A speaker comprising:
a case having a peripheral projection;
a magnetic device having a yoke, and a permanent magnet and secured to the case;
a diaphragm secured to the case at the peripheral projection;
a voice coil secured to an underside of the diaphragm; and
a protector having an upper plate and a cylindrical holding portion at a periphery of the upper plate and secured to the case at the cylindrical holding portion.

2. The speaker according to claim 1 wherein the cylindrical holding portion of the protector has an axial length so as to overlap with the peripheral projection of the case in order to secure the protector to the case.

3. The speaker according to claim 1 further comprising a hold ring provided in the protector for securing the diaphragm to the case.

4. The speaker according to claim 1 wherein the protector has a stepped hold portion between the upper plate and the cylindrical holding portion, and the diaphragm is secured to the case by the stepped hold portion.

5. A method for manufacturing a speaker comprising steps of:
providing an assembly of a case having a peripheral projection and terminals on an underside, thereof and a magnetic device having a yoke, and a permanent magnet;
providing a diaphragm having a voice coil secured to an underside of the diaphragm;
providing a protector having an upper plate and a cylindrical holding portion at a periphery of the upper plate;
mounting the protector on abase in an inverted position;
inserting the voice coil in the protector in an inverted position;
pulling out a pair of ends of the voice coil;
inserting the assembly in the protector in an inverted position;
securing the cylindrical holding portion of the protector to the peripheral projection of the case; and
connecting the ends of the voice coil to the terminals on the case.
